(19) United States
(12) Patent Application Publication
(10) Pub. No.: US 2025/0322379 A1
(43) Pub. Date: Oct. 16, 2025

(54) SYSTEMS AND METHODS FOR TRANSACTING OVER A NETWORK BASED ON AN IDENTIFIER

(71) Applicant: Gen Digital, Inc., Tempe, AZ (US)

(72) Inventors: Iskander Sanchez Rola, Antibes (FR); Michael Shavell, Merrimack, NH (US); Lei Gu, Bedford, MA (US); Alexander Arazi, Redondo Beach, CA (US)

(73) Assignee: Gen Digital, Inc., Tempe, AZ (US)

(21) Appl. No.: 18/636,765

(22) Filed: Apr. 16, 2024

(51) Int. Cl. G06Q 20/32

(52) U.S. Cl. CPC G06Q 20/3224

(57) ABSTRACT

A system and method enables receiving by a computer system a plurality of identifiers respectively corresponding to a plurality of transaction fulfillment systems. A plurality of network locations are scanned to determine a plurality of transaction protocols respectively corresponding to the plurality of transaction fulfillment systems. One or more electronic transactions between a user and one or more of the plurality of transaction fulfillment systems are determined respectively based on one or more of the plurality of identifiers. The computer system detects an electronic transaction request. A particular identifier of the plurality of identifiers is determined based on the plurality of transaction protocols and the one or more electronic transactions, and the computer system initiates a first electronic transaction with a particular transaction fulfillment system of the plurality of transaction fulfillment systems based on the particular identifier to fulfill the electronic transaction request.

### FIELD OF INVENTION

The disclosure relates generally to transacting over a network, and more particularly to determining an identifier for transacting over a network.

### BACKGROUND

Network connectable computer systems such as mobile communication devices, desktop and laptop computers, and cloud-based computing platforms are often configured to store identifiers corresponding to a user for performing transactions with other computing systems. Such transactions can include for example transactions for facilitating consumer purchases, and identifiers can include for example credit card information including a credit card number, a credit card expiration date, and a card verification value (“CVV”).

### SUMMARY

This Summary introduces simplified concepts that are further described below in the Detailed Description of Illustrative Embodiments. This Summary is not intended to identify key features or essential features of the claimed subject matter and is not intended to be used to limit the scope of the claimed subject matter.

A method is provided including receiving by a computer system a plurality of identifiers respectively corresponding to a plurality of transaction fulfillment systems. A plurality of network locations are scanned to determine a plurality of transaction protocols respectively corresponding to the plurality of transaction fulfillment systems. One or more electronic transactions between a user and one or more of the plurality of transaction fulfillment systems are determined respectively based on one or more of the plurality of identifiers. The computer system detects an electronic transaction request. A particular identifier of the plurality of identifiers is determined based on the plurality of transaction protocols and the one or more electronic transactions, and the computer system initiates a first electronic transaction with a particular transaction fulfillment system of the plurality of transaction fulfillment systems based on the particular identifier to fulfill the electronic transaction request.

A computer system is provided including one or more processors and memory storing executable instructions that, as a result of being executed, cause the system to perform operations. The operations include receiving a plurality of identifiers respectively corresponding to a plurality of transaction fulfillment systems and scanning a plurality of network locations to determine a plurality of transaction protocols respectively corresponding to the plurality of transaction fulfillment systems. The operations also include determining one or more electronic transactions between a user and one or more of the plurality of transaction fulfillment systems respectively based on one or more of the plurality of identifiers and detecting an electronic transaction request. The operations further include determining a particular identifier of the plurality of identifiers based on the plurality of transaction protocols and the one or more electronic transactions and initiating a first electronic transaction with a particular transaction fulfillment system of the plurality of transaction fulfillment systems based on the particular identifier to fulfill the electronic transaction request.

Further provided is a non-transitory computer-readable storage medium storing executable instructions that, as a result of execution by one or more processors of a computer system, cause the computer system to perform operations. The operations include receiving a plurality of identifiers respectively corresponding to a plurality of transaction fulfillment systems and scanning a plurality of network locations to determine a plurality of transaction protocols respectively corresponding to the plurality of transaction fulfillment systems. The operations also include determining one or more electronic transactions between a user and one or more of the plurality of transaction fulfillment systems respectively based on one or more of the plurality of identifiers and detecting an electronic transaction request. The operations further include determining a particular identifier of the plurality of identifiers based on the plurality of transaction protocols and the one or more electronic transactions and initiating a first electronic transaction with a particular transaction fulfillment system of the plurality of transaction fulfillment systems based on the particular identifier to fulfill the electronic transaction request.

### BRIEF DESCRIPTION OF THE DRAWINGS

A more detailed understanding may be had from the following description, given by way of example with the accompanying drawings. The Figures in the drawings and the detailed description are examples. The Figures and the detailed description are not to be considered limiting and other examples are possible. Like reference numerals in the Figures indicate like elements wherein:

FIG. 1 shows an environment in which a network-connectable processor-enabled decision manager facilitates identifier selection processes initiated by a computing device operating in a computer network.

FIG. 2 is a diagram showing a process for determining an identifier for completion of a transaction.

FIG. 3 is a diagram showing a process sub-flow which provides a non-limiting exemplary query in the form of the context-based instruction for use in the process of FIG. 2.

FIGS. 4A, 4B, and 4C are hypothetical exemplary displays enabled by a user interface of a computer system according to illustrative embodiments.

FIG. 5 shows a computer system for performing described methods according to illustrative embodiments.

### DETAILED DESCRIPTION OF ILLUSTRATIVE EMBODIMENTS

A challenge of managing identifiers on a computing device lies in the complexity of determining the identifier corresponding to a network connected system which fulfills a particular network-enabled transaction in a manner most beneficial to a user. For example, the challenge of managing multiple credit card identifiers stored on a computing device lies in the complexity of determining the optimal card for each spending scenario to maximize benefits (e.g., “rewards”) to a user. With various cards offering diverse reward structures, bonus categories, and redemption options, individuals often struggle to make well-informed decisions. This results in missed opportunities to earn more points, cash back, or other benefits. Additionally, the necessity to track due dates, annual fees, and ever-changing promotions makes it a logistical and cognitive burden, potentially leading to suboptimal credit card usage, financial inefficiency, and frustration for cardholders.

Network-enabled transactions occurring through particular network addresses may provide additional benefits to users. However, it may be practically impossible for a user to successfully direct a network-enabled transaction to occur through a particular network address to obtain the best benefit for the user. For example, network-accessible online reward shopping portals may be available which provide benefits in reward points or airline miles if a user initiates the shopping activity from the shopping portal itself. For example, a user can receive two reward points from credit card “A” for each dollar spent using credit card “A” at a web interface of a retailer “A” accessed through an online shopping portal “A”, or the user can receive two airline miles per dollar spent using credit card “B” using the web interface of retailer “A” accessed through online shopping portal “B”. It would be beneficial for example for a user to select the network-accessible online reward shopping portal based on a bonus multiplier and a value of the points or based on the user's preferences.

Often computer systems which fulfill transactions enable rotating or changing benefits. For example, many computer systems enable credit card transactions that provide separate opt-in rotating offers programs. These programs add additional layers of complexity for a user. For example, in a particular implementation, a user can receive two reward points from credit card “A” for each dollar spent using credit card “A” at a retailer “A's” web interface accessed through an online shopping portal “A”, whereas a limited time offer on the user's credit card “B” is available for $20 off a $100 purchase without any requirement to make the purchase at a particular retailer or via a particular shopping portal.

Described herein are systems and methods for facilitating transactions by determining an identifier which correspond to a network-accessible computer system providing the most beneficial transaction terms and determining a network accessible system through which a transaction can be routed for greatest benefit to a user. For example, systems and methods described herein provide recommendations and initiate transactions based on credit card numbers and online shopping portals taking into account details of the transactions and optimizing benefits to a user by considering factors such as rewards structures, bonus categories, and user preferences.

As described herein, reference to “first” and “second” components (e.g., a “first electronic transaction,” a “second network address,” a “second model”) or “particular” or “certain” components or implementations (e.g., a “particular identifier,” a “particular text instance,” a “particular transaction fulfillment system”) is not used to show a serial or numerical limitation or a limitation of quality but instead is used to distinguish or identify the various components and implementations.

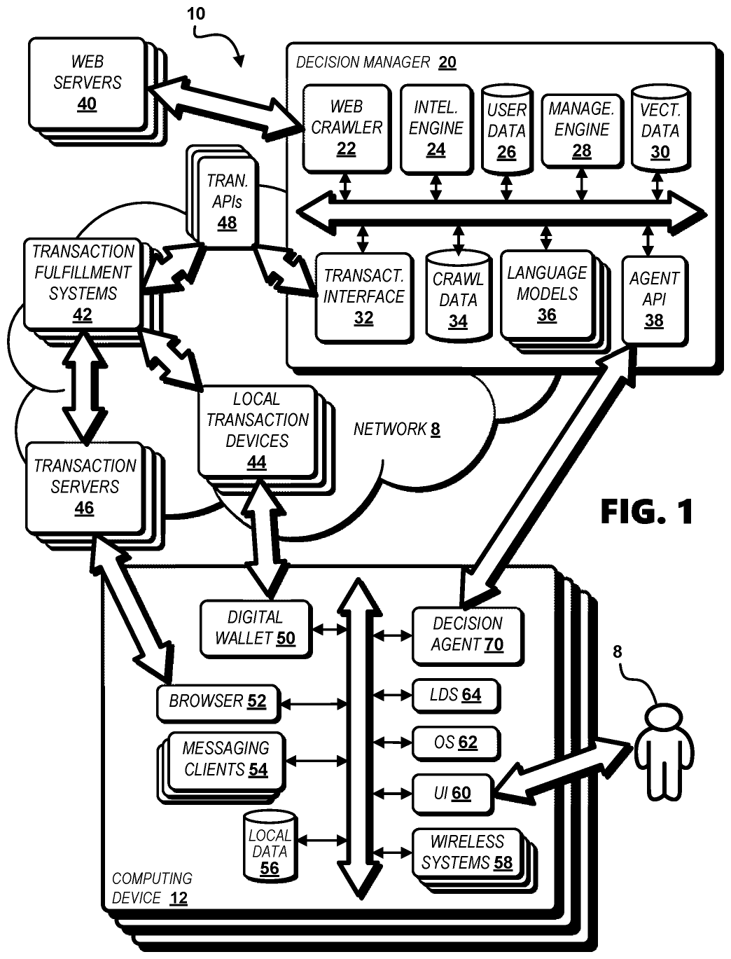

Referring to FIG. 1, an environment 10 enabled by a computer network 8 is illustrated in which a network-connectable processor-enabled decision manager 20 facilitates identifier selection processes initiated by computing devices 12. The computer network 8 includes one or more wired or wireless networks or a combination thereof, for example a local area network (LAN), a wide area network (WAN), the internet, mobile telephone networks, and wireless data networks such as Wi-Fi™ and 3G/4G/5G cellular networks. A decision agent 70, for example one or more of a standalone application, browser extension, browser integration, wallet integration, or wallet extension monitors transactions performed by a digital wallet 50 and monitors network browsing activities and transactions attempted and performed by a browser application (“browser”) 52 on a computing device 12. The decision agent 70 further enables aggregating of transaction data of the user on the computing device 12 and storing of transaction data in a local datastore 56, the transaction data including transactions performed using identifiers (e.g., credit card numbers) corresponding to a user of the computing device. Monitoring by the decision agent 70 provides the decision manager 20 with intelligence data including the transactions performed using identifiers (e.g., credit card numbers) stored by the computing device 12. Data gathered by the decision agent 70 and stored in the local datastore 56 is transmitted by the decision agent 70 and received by the decision manager 20 via an agent application program interface (“API”) 38. The received data is stored in raw or deidentified form by the decision manager 20 in a user datastore 26.

The decision manager 20 includes a web crawler 22, activated by a management engine 28, that gathers information regarding transaction protocols from web servers 40, which information is stored by the decision manager 20 in a crawl datastore 34. The web servers 40 for example are enabled host webpages describing use-based benefits of particular credit cards. The decision manager 20 also aggregates transactions data from a plurality of computing devices 12 via the decision agent 70 executed on the plurality of computing devices 12. The agent API 38 communicates with the decision agent 70 via the computer network 8. Alternatively, the decision manager 20 can be provided as an application on the computing device 12, for example as an integration or extension to the browser 52, and the decision agent 70 can communicate locally with the decision manager 20 via the agent API 38 on the computing device 12. One or more of the components of the decision manager 20 can be cloud-based in communication with one or more other of the components of the decision manager 20 over a network. An operating system 62 (hereinafter “OS 62”) is executed on the computing device 12 which enables integration of the decision agent 70 with the browser 52 and the digital wallet 50. The decision agent 70 is executed on a plurality of computing devices 12 of a plurality of users allowing aggregation by the decision manager 20 of data from the plurality of computing devices 12.

The decision agent 70 detects connections to local transaction devices 44 by the digital wallet 50. Local transaction devices 44 include for example point of sale devices in wireless communication with the computing device 12 via the digital wallet for example through a near field communication protocol or other wireless protocol. The decision agent 70 further detects connections to transaction servers 46 by the browser 52. The transaction servers 46 include for example online retailer systems requiring online credit card payment or other electronic payment methods. Responsive to detecting a connection to a local transaction device 44 or a transaction server 46, the decision agent 70 is configured to select an identifier, for example, corresponding to a particular transaction fulfillment system (e.g., a credit card bank processing system) based on particular criteria to complete the transaction. The decision agent 70 is configured to query the decision manager 20 via the agent API 38 in the process of selecting the identifier. The decision manager 20 via the intelligence engine 24, the user datastore 26, the crawl datastore 34, and one or more language models 36 is enabled to provide a selection of an identifier beneficial to user 8 of the computing device 12 for completion of a transaction via a detected connection. Each language model 36 is beneficially a generative transformer large language model (“LLM”) trained based on publicly available data, for example including public webpages and including 1 billion or more parameters. A non-limiting example generative LLM is the Falcon LLM™ available through The Technology Innovation Institute™ (“TII”™).

The identifier includes for example one or more of a credit card number, an expiration date, or a card verification value (“CVV”). The transaction fulfillment system 42 includes for example a credit card bank processing system for receiving the credit card number, expiration date, and CVV for fulfilling a purchase transaction. The decision agent 70 automatically fills fields with the selected identifier or enters the selected identifier during an electronic transaction to enable completion of the electronic transaction using the selected identifier. A user 8 is enabled to confirm or override the selected identifier used in the transaction. Alternatively, the selected identifier can be provided as suggestion to the user 8 in the user interface 60.

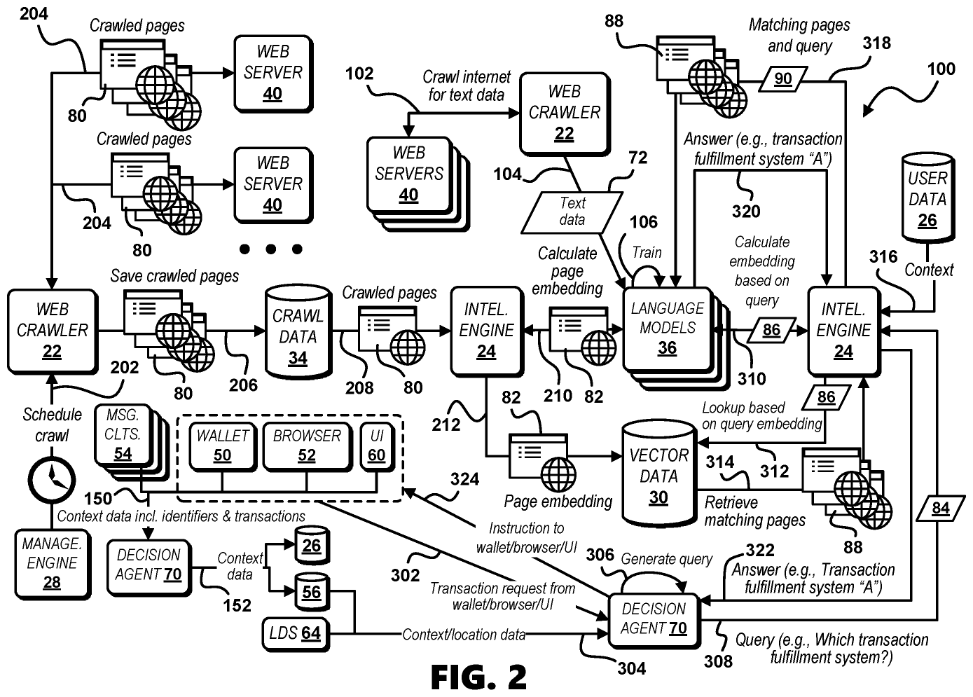

Referring further to FIG. 2, a process flow 100 is shown performed by the components shown in the environment 10 of FIG. 1 for determining an identifier for completion of a transaction. In a step 102, the web crawler 22 crawls the internet for text data 72 in the form of words, phrases, paragraphs, and pages from web servers 40. The text data 72 is provided by the web crawler 22 to the one or more language models (step 104) and used to train the one or more language models (step 106), for example applying zero-shot learning. Different language models 36 can be trained using different text data 72 based on the desired output.

The decision agent 70 periodically or in real time aggregates data (“context data”) from the digital wallet 50, browser 52, user interface 60, and messaging clients 54 (step 150). Context data includes identifiers (e.g., credit card numbers, credit card expiration dates, credit card CVVs) stored by the digital wallet 50 and the browser 52 or otherwise entered by a user 8 via the user interface 60. Context data also includes transaction data showing use of the identifiers (e.g., credit card spending history). Context data further includes transaction protocols gleaned from messages received via messaging clients 54 (e.g., email clients, messaging applications) related to use of the identifiers (e.g., emailed credit card benefit offers). Context data further includes user preferences specified by a user via the user interface 60 regarding use of the identifiers based on transaction protocols (e.g., satisfy a particular credit card offer first). Context data is stored by the decision agent 70 in the local datastore 56 and transmitted to the decision manager 20 via the agent API 38 for storage in the user datastore 26 (step 152).

In a step 202, the management engine 28 transmits a schedule to the web crawler 22 by which the web crawler 22 should crawl web servers 40 (e.g., weekly, monthly). One or more web servers 40 for example host one or more webpages describing use-based benefits of particular credit cards. Based on the schedule, the web crawler 22 crawls the web servers 40 to detect “crawled” pages 80 including text meeting particular criteria (step 204), for example including keywords or key phrases. Detected crawled pages 80 are saved in a crawl datastore 34 (step 206). Crawled pages 80 can be saved for example based on the crawled pages 80 including particular words or phrases or based on application of a natural language processing (“NLP”) model to text of a crawled page 80 by the web crawler 22 to determine a likelihood that the crawled page 80 includes transaction protocols. Transaction protocols can include for example benefits tied to use of a credit card such as airline miles or cash back.

In a step 208, the intelligence engine 24 retrieves from the crawl datastore 34 crawled pages 80. For each retrieved crawled page 80, the intelligence engine 24 queries a language model 36 to calculate a vector embedding 82 (“page embedding” 82) in an embedding space, for example a one thousand to five thousand dimension vector, based on the text included on the crawled page 80 (step 210). The intelligence engine 24 transmits to a vector datastore 30 the page embeddings 82 and their corresponding crawled pages 80 or links to their corresponding crawled pages 80 stored in the crawl datastore 34 (step 212).

In a step 302, the decision agent 70 detects an electronic transaction request. The detecting of an electronic transaction request includes one or more of detecting a connection to a local transaction device 44 by the digital wallet 50, detecting a connection to a transaction server 46 by the browser 52, or receiving an explicit request from a user 8 via the user interface 60. Responsive to detecting the electronic transaction request, the decision agent 70 retrieves context data from the local datastore 56 and location data from the location determining system (“LDS”) 64 (step 304). The computing device determines the location data for example based on one or more of geographic coordinates determined by Global Positioning System hardware, geographic coordinates determined by cell tower triangulation, or detection of wireless access points of known location. The location data includes for example an indication of an address or establishment name or establishment type situated at the geographic coordinates where the computing device 12 is located during an attempted transaction with a local transaction device 44. Alternatively, or additionally, the decision agent 70 retrieves context data from the user datastore 26 managed by the decision manager 20.

Further responsive to detecting the electronic transaction request, the decision agent 70 generates a query 84 (step 306) and transmits the query to the intelligence engine 24 (step 308). The query 84 includes a request for information for identifying which of a plurality of identifiers managed by the user 8 via one or more of the digital wallet 50, the browser 52, or the local datastore 56 is most suitable for fulfilling a transaction. The query 84 is beneficially based on the context data, the location data, or a combination of the context data and the location data received in step 304. The query 84 beneficially includes a request for information useful for identifying a transaction fulfillment system 42 associated with an identifier stored by the computing device 12 (e.g., a request for a credit card name), and the identifier (e.g., a credit card number) is useful to initiate a transaction with the transaction fulfillment system 42. The query additionally or alternatively includes a request for information for identifying a network address (e.g., including a shopping portal) through which to direct the transaction to obtain the best benefit to the user 8.

In an example implementation, the query 84 generated in step 306 includes a request to determine the credit card with the most beneficial offer out of a list of credit cards associated with respective identifiers in the digital wallet 50 of a computing device 12 operated by a user 8. In another example implementation, the query 84 includes a request to determine the credit card providing the most airline miles out of a list of credit cards associated with identifiers in the digital wallet 50 of a computing device 12 operated by a user 8. In another example implementation the query includes “Find best travel credit card offer.”

The decision agent 70 transmits the query 84 in sentence form or paragraph form to the intelligence engine 24 (step 308). The intelligence engine 24 queries the language model 36 used to calculate the page embedding 82 based on the query 84 received from the decision agent 70 (step 310). The intelligence engine 24 can supplement the query 84 received from the decision agent 70 with data from the user datastore 26. The language model 36 generates an embedding 86 based on the query 84 from the intelligence engine 24 and provides the embedding (“query embedding” 86) to the intelligence engine 24. The query embedding 86 is beneficially a vector of the same number of dimensions as the page embeddings 82, for example a one thousand to five thousand dimension vector. The intelligence engine 24 performs a lookup on the vector datastore 30 to compare the query embedding 86 to the page embeddings 82 to determine similar embeddings (step 312). Page embeddings 82 are selected that are similar to the query embedding 86, for example having a cosine similarity close to one (1), and matching pages 88 corresponding to the selected page embeddings 82 or network links to the matching pages 88 (e.g., URLs) are provided to the intelligence engine 24 (step 314).

The intelligence engine 24 supplements the query 84 received from the decision agent 70 with context data from the user datastore 26, for example context data from network-accessible sources (e.g., web servers 40), from the computing device 12 from which the query 84 was received, or from other computing devices 12, to generate another query 90 (step 316). Alternatively, the query 90 is identical to the query 84 without supplemented data. The intelligence engine 24 queries the language model 36 based on the matching pages 88 and the query 90 (step 318). The language model 36 used in step 318 can be the same language model 36 used in determining the embeddings in steps 210 and 310, or alternatively, a separately trained language model 36. The language model 36 returns an answer to the query 90 in the form of information for identifying which of the plurality of identifiers managed by the user 8 via one or more of the digital wallet 50, the browser 52, or the local datastore 56 is most suitable for fulfilling a transaction (step 320). The answer additionally or alternatively includes information for identifying a network address (e.g., including a shopping portal) through which to direct the transaction to obtain the best benefit to the user 8. The intelligence engine 24 transmits the answer to the decision agent 70 (step 322).

The decision agent 70 performs an action based on the answer in the form of an instruction to one or more of the digital wallet 50, browser 52, or the user interface 60 (step 324). The instruction provides an indication of the identifier most suitable for performing the transaction. The instruction can be provided for example in the form of identification of a credit card for completing a merchant transaction. The instruction can for example initiate automatically filling by the browser 52 one or more identifiers (e.g., credit card information including account holder name, credit card number, expiration date, and CCV) into fields of a webpage opened by the browser 52 to complete a transaction. The instruction can alternatively for example initiate automatic selection by the digital wallet 50 of one or more identifiers for completing a transaction, for example selection by the digital wallet 50 of credit card information for a particular credit card determined to be most suitable for a transaction. The instruction can alternatively for example provide a notice in the user interface 60 to instruct the user regarding the credit card most suitable for completing a transaction.

The instruction in step 324 additionally or alternatively includes an indication of a network address through which to redirect the transaction to obtain the best benefit to the user 8. The instruction initiates a redirection by the browser 52 from a first transaction server 46 to a second transaction server 46 (e.g., including a shopping portal) through which the first transaction server 46 is accessed via the browser 52 to complete the transaction. Accessing the first transaction server 46 through the second transaction server 46 via the browser 52 may for example provide a monetary benefit to the user 8.

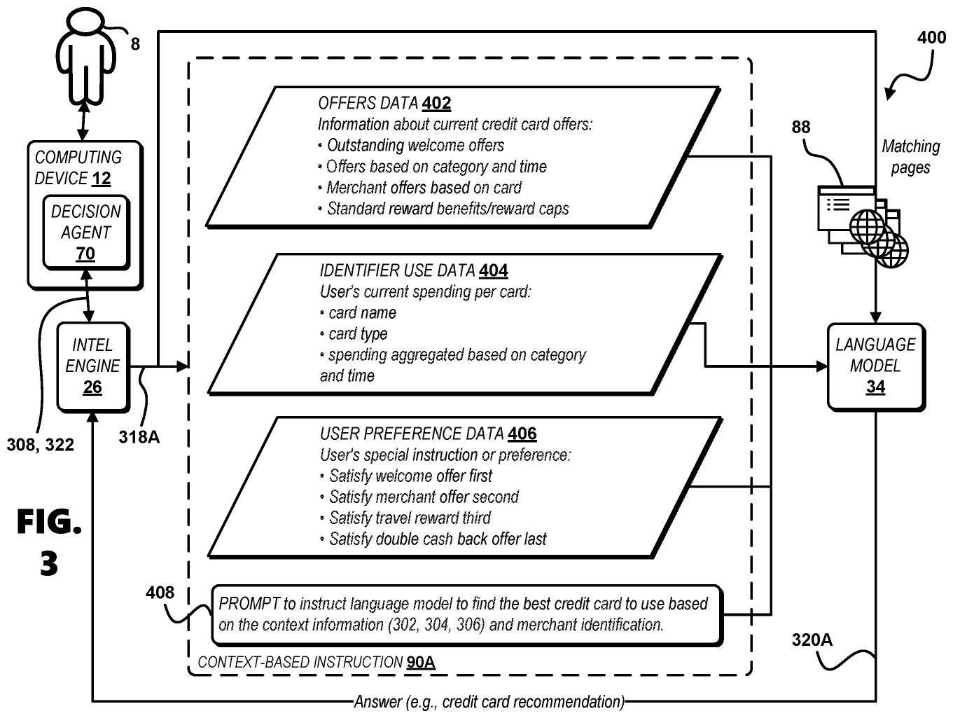

Referring to FIG. 3, a process sub-flow 400 is shown which provides a non-limiting exemplary query 90 in the form of a context-based instruction 90A for use in the process flow 100 of FIG. 2. In the exemplary process sub-flow 400 steps 318A and 320A are non-limiting examples of steps 318 and 320, respectively. In the step 318A, the query 90 is transmitted to the language model 36 in the form of the context-based instruction 90A. The context-based instruction 90A includes context information including offers data 402, identifier use data 404, and user preferences data 406.

The offers data 402 includes data determined by the crawling by the web crawler 22 in step 204. The decision agent 70 monitors messages received by the user via messaging clients 54 which include email clients, short message service (“SMS”) clients, and other messaging applications, and the offers data 402 further includes data determined by the monitoring. The offers data 402 includes information about credit card offers including one or more of outstanding welcome offers, offers based on category and time, merchant offers based on credit card, standard reward benefits, and reward benefit caps. Regarding reward benefit caps for example, a particular credit card may offer 5% cash back on gasoline until a dollar limit of $8000 of gasoline purchases is reached. Under such circumstances, the language model 36 can suggest use of the particular credit card until the dollar amount charged on the card reflected in the identifier use data 404 reaches the dollar limit, after which subsequent answers from the language model 36 can suggest a credit card offering better benefits.

The decision agent 70 monitors use of identifiers (e.g., credit card identifiers) to complete transactions via the digital wallet 50 and the browser 52, and the identifier use data 404 includes data determined by the monitoring of the use of the identifiers. To further aggregate the identifier use data 404, the decision manager 20 via a transaction interface 32 queries transactions (e.g., credit card purchases) fulfilled by the transaction fulfillment systems 42 for the user 8 via transaction application program interfaces (“APIs”) 48 in communication with the transaction fulfillment systems 42. The identifier use data 404 includes credit card name, credit card type, and spending aggregated based on category and time.

The decision agent 70 receives the user preference data 406 from the user 8 via the user interface 60 by initiating a questionnaire. The user preference data 406 includes for example a particular user preference to satisfy a credit card welcome offer first, satisfy a merchant offer second, satisfy a travel reward third, and satisfy a double cash back offer last.

The context-based instruction 90A further includes a prompt 408 to instruct the language model 36 to find the best user identifier for completing a transaction based on the context information. The prompt 408 beneficially further includes an indication of the local transaction device 44 or the transaction server 46 to which the digital wallet 50 or the browser 52 is connected to enable the transaction. The prompt 408 for example instructs the language model 36 to find the best credit card for completing a transaction based on the offers data 402, the identifier use data 404, and the user preferences data 406, and beneficially also based on an identification of a merchant with which a transaction is attempted via the digital wallet 50 or the browser 52. The language model 36 determines an answer based on the context-based instruction 90A and the matching pages 88 and delivers an answer including a credit card recommendation (step 320A). The intelligence engine 24 passes the answer to the decision agent 70 in step 322 which performs an action (step 324) based on the answer in the form of an instruction to one or more of the digital wallet 50, browser 52, or the user interface 60.

In a hypothetical exemplary application of the process flow 100, a user 8 is looking to optimize her credit card usage for specific expenses. When it comes to purchasing gasoline, the decision agent 70 (based on answers from the intelligence engine 24) recommends the user 8 use her “Blue Cash Preferred from American Express™” credit card, which earns the user 8 3% cash back on U.S. gas station purchases, helping her save on fuel costs. For dining out with friends or ordering takeout, the decision agent 70 recommends the user 8 use her “Chase Sapphire Reserve™” credit card, which gives her “3×Ultimate Rewards™ ” points on restaurant spending, allowing the user 8 to accumulate valuable rewards for her love of healthy food. And when it is time for a haircut or salon visit, the decision agent 70 recommends the user 8 use “Citi Custom Cash Card™ ” credit card, which is a flexible choice because the card automatically provides maximum cash back for her biggest spending category, providing 5% cash back on the highest monthly spend category in each billing cycle. The decision agent 70 beneficially implements the recommendation without action of the user, allowing the user to opt out of the credit card choice implemented by the decision agent 70, and the decision agent 70 initiates payment with the selected credit card via the digital wallet 50 or the browser 52.

The process flow 100 enabled by the decision manager 20 and the decision agent 70 allows users to gain the maximum benefit afforded by a plurality of stored identifiers (e.g., credit card identifiers) for completing a transaction. The recommendations and actions encompass various aspects, including cases such as checking the real-time GPS location, applications running on the computing device 12, previous transaction history (e.g., shopping history), general benefits (e.g., credit card benefits), user preferences, and temporary promotions. Users can leverage these recommendations in several ways, such as receiving notifications for each scenario or utilizing a generic identifier (e.g., generic credit card) that automatically directs payments to the most suitable credit card without requiring any additional user intervention.

A user 8 is further enabled to set an objective via the decision agent 70. An example of this is where certain credit cards offer major benefits at certain milestones such as travel cards giving a particular number of points when a certain amount of spending has been achieved. For such case, a user has the ability to select the objective and override the decision agent 70 to focus on user-selected goals as opposed to the optimal goal (e.g., optimal financial goal) as identified by the decision agent 70 via the intelligence engine 24 and the language model 36. Further, the decision agent 70 automatically directs a user 8 to the most appropriate shopping portal via the browser 52 based on the current shopping site, based on total cash equivalents of bonus points or miles (e.g., Chase™ reward point vs. United Miles™), ongoing promotions, or user's preference (like Chase Reward™ points only).

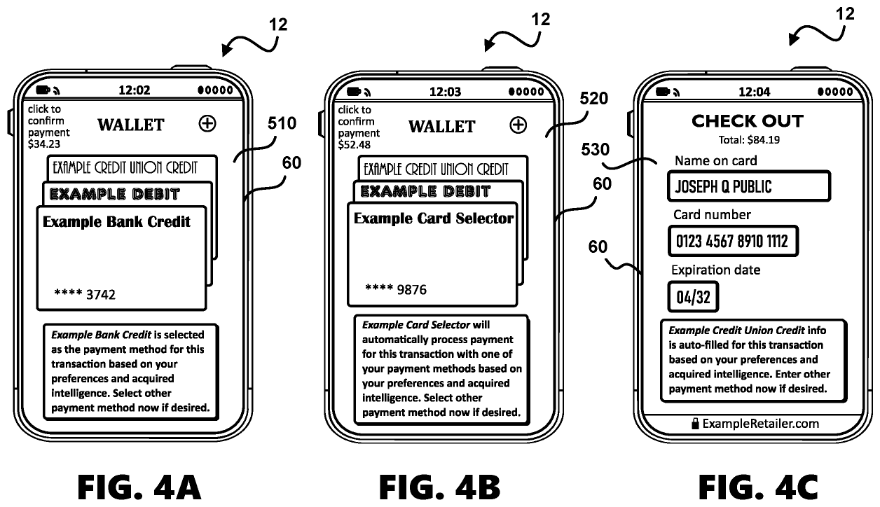

Referring to FIG. 4A, a computing device 12 is shown in which a hypothetical exemplary first display 510 is generated by the digital wallet 50 and enabled by the user interface 60 responsive to an instruction in step 324 from the decision agent 70. The first display 510 indicates that “Example Bank Credit is selected as the payment method for this transaction based on your preferences and acquired intelligence. Select other payment method now if desired.” The user 8 is enabled to confirm payment using the selected payment method via the user interface 60 or select another payment method with which to complete the transaction.

Referring to FIG. 4B, a computing device 12 is shown in which a hypothetical exemplary second display 520 is generated by the digital wallet 50 and enabled by the user interface 60 responsive to an instruction in step 324 from the decision agent 70. The second display 520 indicates that “Example Card Selector will automatically process payment for this transaction with one of your payment methods based on your preferences and acquired intelligence. Select other payment method now if desired.” The user 8 is enabled to confirm payment using the Example Card Selector via the user interface 60 or select another payment method with which to complete the transaction. The Example Card Selector functions as a generic card including a generic identifier. By a user 8 confirming payment using the Example Card Selector, a payment method (e.g., credit card) is selected by the digital wallet 50 based on the instruction in step 324 from the decision agent 70. Alternatively, the second display 520 is generated by the digital wallet 50 prior to the decision agent 70 transmitting the query 84 in step 308 and prior to the decision agent 70 receiving the answer in step 322, and the actual payment method is determined by the process flow 100 after the user 8 confirms the transaction using the “Example Card Selector.”

Referring to FIG. 4C, a computing device 12 is shown in which a hypothetical exemplary third display 530 is generated by the browser 52 and enabled by the user interface 60 responsive to an instruction in step 324 from the decision agent 70. The third display 530 indicates that “Example Credit Union Credit info is auto-filled for this transaction based on your preferences and acquired intelligence. Enter other payment method now if desired.” The user 8 is enabled to confirm payment using the selected payment method via the user interface 60 or enter manually another payment method with which to complete the transaction.

Further to the description above and referring to FIGS. 1 and 2, the process flow 100 enables a method for initiating a transaction over a network. The method is described with reference to the steps and components of the process flow 100 in which a computer system is depicted as a computing device 12. The depictions of the components performing steps of the process flow 100 are exemplary in nature, and the process flow 100 is not limited by the particular naming of each component.

The method enabled by the process flow 100 includes receiving by a computing device 12 (i.e., a computer system) a plurality of identifiers (e.g., credit card numbers) respectively corresponding to a plurality of transaction fulfillment systems 42 (e.g., credit card transaction fulfillment systems) (step 150). A plurality of network locations are scanned (e.g., by the web crawler 22) to determine a plurality of transaction protocols (e.g., benefit program rules) respectively corresponding to the plurality of transaction fulfillment systems 42 (step 204). One or more electronic transactions between a user 8 and one or more of the plurality of transaction fulfillment systems 42 (e.g., a credit card transaction history) are determined respectively based on one or more of the plurality of identifiers, for example via the computing device 12 (step 150). For example, the computing device 12 determines a plurality of electronic transactions between the user and the plurality of transaction fulfillment systems respectively based on the plurality of identifiers (step 150). The computing device 12 detects an electronic transaction request, for example an online checkout webpage enabled via the browser 52, a payment request to the digital wallet 50 from a local transaction device 44 at a point-of-sale, or a query via the UI 60 from the user 8 (step 302). A particular identifier of the plurality of identifiers is determined based on the plurality of transaction protocols and the one or more electronic transactions (steps 312, 314, 318, 320), and the computer device 12 initiates a first electronic transaction with a particular transaction fulfillment system 42 of the plurality of transaction fulfillment systems 42 based on the particular identifier to fulfill the electronic transaction request (step 324).

The computing device 12 can further determine a source of the electronic transaction request (e.g., a local transaction device 44 or a transaction server 46) (step 304), and the particular identifier of the plurality of identifiers can be determined further based on the source of the electronic transaction request (steps 312, 314, 318, 320). In a particular implementation, the computing device 12 measures wireless signals and determines the source of the electronic transaction request based on the measuring of the wireless signals. For example, the computing device 12 determines a geographic location based on the wireless signals, and the computing device 12 determines the source of the electronic transaction request based on the geographic location (step 304).

In a particular implementation, the computing device 12 enables the browser 52 and detects the electronic transaction request via the browser 52 via a first network address (step 302), wherein initiating the particular transaction includes filling by the computing device 12 the particular identifier into fields of a webpage via the browser 52 (step 324).

In another particular implementation, the computing device 12 enables the browser 52 and detects the electronic transaction request via the browser 52 via a first network address (step 302). The computing device 12 is redirected via the browser 52 to a second network address (e.g., hosting a shopping portal) based on the first network address, the plurality of transaction protocols, and the one or more electronic transactions, and the computing device 12 initiates the first electronic transaction via the second network address (step 324). Referring also to FIG. 3, the computing device 12 can receive from the user 8 via the computer device 12 one or more transaction thresholds (e.g., user preference data 406, milestones) corresponding to one or more of the plurality of transaction protocols (steps 150, 304) and redirect the computing device 12 via the browser 52 to the second network address further based on the one or more transaction thresholds (step 324).

Referring also to FIGS. 4A, 4B, and 4C, the computing device 12 is enabled to provide via a user interface 60 an indication of the particular identifier (e.g., the first display 510, the second display 520, the third display 530), receive via the user interface 60 a confirmation of the particular identifier, and initiate the first electronic transaction responsive to the confirmation (step 324).

In another particular implementation, the computing device 12 receives from the user 8 one or more transaction thresholds (e.g., user preference data 406, milestones) corresponding to one or more of the plurality of transaction protocols (step 150, 304) and determines the particular identifier further based on the one or more transaction thresholds (steps 312, 314, 318, 320).

The method enabled by the process flow 100 can further include determining a plurality of text instances (e.g., of crawled pages 80) based on the scanning of the plurality of network locations (step 204) and calculating a plurality of embeddings (e.g., page embeddings 82) respectively based on the plurality of text instances (step 210). Another embedding (e.g., query embedding 86) is calculated based on the electronic transaction request (step 310) and the another embedding (e.g., query embedding 86) is compared to the plurality of embeddings (e.g., page embeddings 82) to determine one or more particular text instances (e.g., of a matching page 88) of the plurality of text instances (steps 312, 314). A language model 36 is applied to the one or more particular text instances and the one or more electronic transactions to determine the particular identifier of the plurality of identifiers (steps 318, 320). In a particular implementation, the language model 36 is applied to the plurality of text instances to calculate the plurality of embeddings (e.g., page embeddings 82) (step 210), a query 84 is generated based on the electronic transaction request (306), and the language model 36 is applied to the query 84 to calculate the another embedding (310). Beneficially, other network locations (e.g., web servers 40) are scanned, for example by the web crawler 22, to determine other text instances (e.g., text data 72) (step 102), and the language model 36 is trained based on the other text instances (step 106).

In another particular implementation, the method enabled by the process flow 100 can further include determining a plurality of text instances (e.g., of crawled pages 80) based on the scanning of the plurality of network locations (step 204). A first language model 36 is applied to calculate a plurality of embeddings (e.g., page embeddings 82) respectively based on the plurality of text instances (step 210). The first language model 36 is applied to calculate another embedding (e.g., query embedding 86) based on the electronic transaction request (step 310). The another embedding (e.g., query embedding 86) is compared to the plurality of embeddings (e.g., page embeddings 82) to determine one or more particular text instances (e.g., of a matching page 88) of the plurality of text instances (steps 312, 314). A second language model 36 is applied to the one or more particular text instances and the one or more electronic transactions to determine the particular identifier of the plurality of identifiers (steps 318, 320).

The method enabled by the process flow 100 can further include detecting one or more electronic messages received by the computing device 12, the one or more electronic messages including one or more other transaction protocols (step 150). Determining the particular identifier is further based on the one or more other transaction protocols (steps 312, 314, 318, 320).

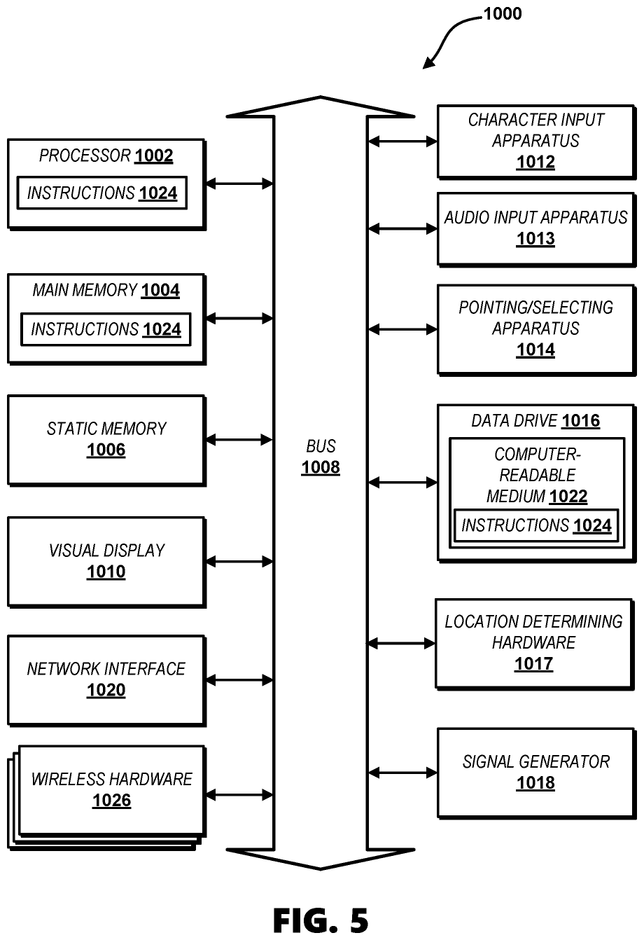

FIG. 5 illustrates in abstract the function of an exemplary computer system 1000 on which the systems, methods and processes described herein can execute. For example, the computing device 12, decision manager 20 and its components, web servers 40, transaction fulfillment systems 42, local transaction devices 44, and transaction servers 46 can each be embodied by a particular computer system 1000 or a plurality of computer systems 1000. The computer system 1000 may be provided in the form of a personal computer, laptop, handheld mobile communication device, mainframe, distributed computing system, or other suitable configuration. Illustrative subject matter is in some instances described herein as computer-executable instructions, for example in the form of program modules, which program modules can include programs, routines, objects, data structures, components, or architecture configured to perform particular tasks or implement particular abstract data types. The computer-executable instructions are represented for example by instructions 1024 executable by the computer system 1000.

The computer system 1000 can operate as a standalone device or can be connected (e.g., networked) to other machines. In a networked deployment, the computer system 1000 may operate in the capacity of a server or a client machine in a server-client network environment, or as a peer machine in a peer-to-peer (or distributed) network environment. The computer system 1000 can also be considered to include a collection of machines that individually or jointly execute a set (or multiple sets) of instructions to perform one or more of the methodologies described herein, for example in a cloud computing environment.

It would be understood by those skilled in the art that other computer systems including but not limited to networkable personal computers, minicomputers, mainframe computers, handheld mobile communication devices, multiprocessor systems, microprocessor-based or programmable electronics, and smart phones could be used to enable the systems, methods and processes described herein. Such computer systems can moreover be configured as distributed computer environments where program modules are enabled and tasks are performed by processing devices linked through a computer network, and in which program modules can be located in both local and remote memory storage devices.

The exemplary computer system 1000 includes a processor 1002, for example a central processing unit (CPU) or a graphics processing unit (GPU), a main memory 1004, and a static memory 1006 in communication via a bus 1008. A visual display 1010, for example a liquid crystal display (LCD), a light emitting diode (LED) display, or a cathode ray tube (CRT) is provided for displaying data to a user of the computer system 1000. The visual display 1010 can be enabled to receive data input from a user, for example via a resistive or capacitive touch screen. A character input apparatus 1012 can be provided for example in the form of a physical keyboard, or alternatively, a program module which enables a user-interactive simulated keyboard on the visual display 1010 and actuatable for example using a resistive or capacitive touchscreen. An audio input apparatus 1013, for example a microphone, enables audible language input which can be converted to textual input by the processor 1002 via the instructions 1024. A pointing/selecting apparatus 1014 can be provided, for example in the form of a computer mouse or enabled via a resistive or capacitive touch screen in the visual display 1010. A data drive 1016, a signal generator 1018 such as an audio speaker, and a network interface 1020 can also be provided. Location determining hardware 1017 is also provided which can include for example a GPS receiver and supporting hardware. A plurality of wireless hardware 1026 are provided enabling cellular communication, local area network communication (e.g., Wi-Fi™), near-field communication (“NFC”), and short-range UHF (e.g., Bluetooth™) communication.

The instructions 1024 and data structures embodying or used by the herein-described systems, methods, and processes, for example software instructions, are stored on a computer-readable medium 1022 and are accessible via the data drive 1016. Further, the instructions 1024 can completely or partially reside for a particular time period in the main memory 1004 or within the processor 1002 when the instructions 1024 are executed. The main memory 1004 and the processor 1002 are also as such considered computer-readable media.

While the computer-readable medium 1022 is shown as a single medium, the computer-readable medium 1022 can be considered to include a single medium or multiple media, for example in a centralized or distributed database, or associated caches and servers, that store the instructions 1024. The computer-readable medium 1022 can be considered to include any tangible medium that can store, encode, or carry instructions for execution by a machine and that cause the machine to perform any one or more of the methodologies described herein, or that can store, encode, or carry data structures used by or associated with such instructions. Further, the term “computer-readable storage medium” can be considered to include, but is not limited to, solid-state memories and optical and magnetic media that can store information in a non-transitory manner. Computer-readable media can for example include non-volatile memory such as semiconductor memory devices (e.g., magnetic disks such as internal hard disks and removable disks, magneto-optical disks, CD-ROM and DVD-ROM disks, Erasable Programmable Read-Only Memory (EPROM), Electrically Erasable Programmable Read-Only Memory (EEPROM), and flash memory devices).

The instructions 1024 can be transmitted or received over a computer network, for example the computer network 8, using a signal transmission medium via the network interface 1020 operating under one or more known transfer protocols, for example FTP, HTTP, or HTTPs. Examples of computer networks include a local area network (LAN), a wide area network (WAN), the internet, mobile telephone networks, Plain Old Telephone (POTS) networks, and wireless data networks, for example Wi-Fi™ and 3G/4G/5G cellular networks. The term “computer-readable signal medium” can be considered to include any transitory intangible medium that is capable of storing, encoding, or carrying instructions for execution by a machine, and includes digital or analog communications signals or other intangible medium to facilitate communication of such instructions.

Although features and elements are described above in particular combinations, one of ordinary skill in the art will appreciate that each feature or element can be used alone or in any combination with the other features and elements. Methods described herein may be implemented in a computer program, software, or firmware incorporated in a computer-readable medium for execution by a computer or processor.

While embodiments have been described in detail above, these embodiments are non-limiting and should be considered as merely exemplary. Modifications and extensions may be developed, and all such modifications are deemed to be within the scope defined by the appended claims.

What is claimed is:

1. A method comprising:
receiving, by a computer system, a plurality of identifiers respectively corresponding to a plurality of transaction fulfillment systems;
scanning a plurality of network locations to determine a plurality of transaction protocols respectively corresponding to the plurality of transaction fulfillment systems;
determining at least one electronic transaction between a user and at least one of the plurality of transaction fulfillment systems respectively based on at least one of the plurality of identifiers;
detecting by the computer system an electronic transaction request;
determining a particular identifier of the plurality of identifiers based on the plurality of transaction protocols and the at least one electronic transaction; and
initiating a first electronic transaction with a particular transaction fulfillment system of the plurality of transaction fulfillment systems based on the particular identifier to fulfill the electronic transaction request.

2. The method of claim 1, further comprising:
determining by the computer system a source of the electronic transaction request; and
determining the particular identifier of the plurality of identifiers further based on the source of the electronic transaction request.

3. The method of claim 2, further comprising:
measuring wireless signals by the computer system; and
determining the source of the electronic transaction request based on the measuring of the wireless signals.

4. The method of claim 3, further comprising:
determining by the computer system a geographic location based on the wireless signals; and
determining the source of the electronic transaction request based on the geographic location.

5. The method of claim 1, further comprising:
enabling by the computer system a browser;
detecting by the computer system the electronic transaction request via the browser via a first network address; and
wherein initiating the first electronic transaction comprises filling by the computer system the particular identifier into fields of a webpage via the browser.

6. The method of claim 1, further comprising:
enabling by the computer system a browser;
detecting by the computer system the electronic transaction request via the browser via a first network address;
redirecting the computer system via the browser to a second network address based on the first network address, the plurality of transaction protocols, and the at least one electronic transaction; and
initiating the first electronic transaction via the second network address.

7. The method of claim 6 further comprising:
receiving from the user via the computer system at least one transaction threshold corresponding to at least one of the plurality of transaction protocols; and
redirecting the computer system via the browser to the second network address further based on the at least one transaction threshold.

8. The method of claim 1, further comprising:
providing by the computer system via a user interface an indication of the particular identifier;
receiving via the computer system via the user interface a confirmation of the particular identifier; and
initiating the first electronic transaction responsive to the confirmation.

9. The method of claim 1, further comprising:
receiving from the user via the computer system at least one transaction threshold corresponding to at least one of the plurality of transaction protocols; and
determining the particular identifier further based on the at least one transaction threshold.

10. The method of claim 1, further comprising:
determining a plurality of text instances based on the scanning of the plurality of network locations;
calculating a plurality of embeddings respectively based on the plurality of text instances;
calculating another embedding based on the electronic transaction request;
comparing the another embedding to the plurality of embeddings to determine at least one particular text instance of the plurality of text instances; and
applying a model to the at least one particular text instance and the at least one electronic transaction to determine the particular identifier of the plurality of identifiers.

11. The method of claim 10, further comprising:
applying the model to the plurality of text instances to calculate the plurality of embeddings;
generating a query based on the electronic transaction request; and
applying the model to the query to calculate the another embedding.

12. The method of claim 10, further comprising:
scanning other network locations to determine other text instances; and
training the model based on the other text instances.

13. The method of claim 12, wherein the model comprises a generative large language model.

14. The method of claim 1, further comprising determining a plurality of text instances based on the scanning of the plurality of network locations;
applying a first model to calculate a plurality of embeddings respectively based on the plurality of text instances;
applying the first model to calculate another embedding based on the electronic transaction request;
comparing the another embedding to the plurality of embeddings to determine at least one particular text instance of the plurality of text instances; and
applying a second model to the at least one particular text instance and the at least one electronic transaction to determine the particular identifier of the plurality of identifiers.

15. The method of claim 1, further comprising:
detecting at least one electronic message received by the computer system, the at least one electronic message comprising at least one other transaction protocol; and
determining the particular identifier further based on the at least one other transaction protocol.

16. The method of claim 1, further comprising:
determining by the computer system a plurality of electronic transactions between the user and the plurality of transaction fulfillment systems respectively based on the plurality of identifiers; and
determining the particular identifier of the plurality of identifiers based on the plurality of transaction protocols and the plurality of electronic transactions.

17. A computer system, comprising:
one or more processors; and
memory storing executable instructions that, as a result of being executed, cause the computer system to perform operations comprising:
receiving a plurality of identifiers respectively corresponding to a plurality of transaction fulfillment systems;
scanning a plurality of network locations to determine a plurality of transaction protocols respectively corresponding to the plurality of transaction fulfillment systems;
determining at least one electronic transaction between a user and at least one of the plurality of transaction fulfillment systems respectively based on at least one of the plurality of identifiers;
detecting an electronic transaction request;
determining a particular identifier of the plurality of identifiers based on the plurality of transaction protocols and the at least one electronic transaction; and
initiating a first electronic transaction with a particular transaction fulfillment system of the plurality of transaction fulfillment systems based on the particular identifier to fulfill the electronic transaction request.

18. The computer system of claim 17, the executable instructions, as a result of being executed, further causing the computer system to perform operations comprising:
scanning other network locations to determine text instances;
training a model based on the text instances; and
determining the particular identifier further based on the model.

19. The computer system of claim 17, the executable instructions, as a result of being executed, further causing the computer system to perform operations comprising:
determining a plurality of text instances based on the scanning of the plurality of network locations;
scanning other network locations to determine other text instances;
training a model based on the other text instances;
applying the model to the plurality of text instances to calculate a plurality of embeddings;
generating a query based on the electronic transaction request;
applying the model to the query to calculate another embedding;
comparing the another embedding to the plurality of embeddings to determine at least one particular text instance of the plurality of text instances; and
determining the particular identifier based on the at least one particular text instance and the at least one electronic transaction.

20. The computer system of claim 19, the executable instructions, as a result of being executed, further causing the computer system to perform operations comprising:
detecting at least one electronic message received by the computer system, the at least one electronic message comprising at least one other transaction protocol; and
generating the query further based on the at least one electronic transaction and the at least one other transaction protocol.

21. The computer system of claim 19, the executable instructions, as a result of being executed, further causing the computer system to perform operations comprising:
measuring wireless signals by the computer system;
determining a source of the electronic transaction request based on the measuring the wireless signals; and
generating the query further based on the at least one electronic transaction and the source of the electronic transaction request.

22. A non-transitory computer-readable storage medium storing executable instructions that, as a result of execution by one or more processors of a computer system, cause the computer system to perform operations comprising:
receiving a plurality of identifiers respectively corresponding to a plurality of transaction fulfillment systems;
scanning a plurality of network locations to determine a plurality of transaction protocols respectively corresponding to the plurality of transaction fulfillment systems;
determining at least one electronic transaction between a user and at least one of the plurality of transaction fulfillment systems respectively based on at least one of the plurality of identifiers;
detecting an electronic transaction request;
determining a particular identifier of the plurality of identifiers based on the plurality of transaction protocols and the at least one electronic transaction; and
initiating a first electronic transaction with a particular transaction fulfillment system of the plurality of transaction fulfillment systems based on the particular identifier to fulfill the electronic transaction request.
